(19) United States
(12) Patent Application Publication
(10) Pub. No.: US 2025/0126432 A1
(43) Pub. Date: Apr. 17, 2025

(54) Spectrogram Localization Algorithm

(71) Applicant: Nicolas John Gault, St. Augustine, FL (US)

(72) Inventor: Nicolas John Gault, St. Augustine, FL (US)

(21) Appl. No.: 18/914,030

(22) Filed: Oct. 11, 2024

Related U.S. Application Data
(60) Provisional application No. 63/589,885, filed on Oct. 12, 2023.

(51) Int. Cl. H04S 7/00; G10L 19/038

(52) U.S. Cl. CPC H04S 7/40; G10L 19/038

(57) ABSTRACT

The Spectrogram Localization Algorithm is an innovative method for real-time audio visualization that merges spectrograms and vectorscopes to provide a comprehensive display of audio signals. By mapping frequencies on the y-axis and stereo localization on the x-axis, it shows frequencies at their pitches and spatial positions, with colors and widths representing amplitudes. Utilizing a custom Short-Time Fourier Transform (STFT) optimized for real-time processing, the algorithm calculates amplitude and phase differences between left and right channels for each frequency bin. This approach aligns with human auditory perception, offering audio professionals an intuitive tool to analyze and adjust audio signals, enhancing frequency content management and spatial localization in mixes.

### CROSS-REFERENCE TO RELATED APPLICATIONS

The current application claims a priority to the U.S. provisional patent application Ser. No. 63/589,885 filed on Oct. 12, 2023.

### FIELD OF THE INVENTION

The present invention relates to the field of audio processing and visualization. More specifically, it pertains to a method and system for real-time audio visualization that integrates frequency content and stereo localization into a single, comprehensive display, enhancing the analysis and manipulation of audio signals in a manner consistent with human auditory perception.

### BACKGROUND OF THE INVENTION

In the realm of audio processing and analysis, visual tools such as spectrograms and vectorscopes are extensively utilized to represent sound signals. Spectrograms display the frequency content of a signal over time, plotting frequencies against amplitude. However, they lack representation of stereo imaging, making it challenging to analyze spatial characteristics of audio signals.

Vectorscopes provide a two-dimensional representation of the stereo field, showcasing amplitude differences and phase correlation between the left and right channels. Yet, they do not allow for detailed inspection of specific frequencies or frequency ranges.

Traditional spectrograms plot frequencies linearly or logarithmically on the x-axis from low to high frequencies, which does not align with human auditory perception where spatial localization is associated with stereo imaging rather than frequency position. Moreover, spectrograms do not account for stereo field information, making it difficult to analyze how different frequencies are positioned within the stereo space.

Vectorscopes, while useful for visualizing overall stereo balance and phase correlation, are dominated by low-frequency content, which can obscure the stereo characteristics of higher frequencies. They also lack detailed frequency-specific information, limiting the ability to identify and adjust specific frequencies that may be problematic in a mix.

These limitations in existing tools pose challenges for audio engineers who need to analyze and adjust audio signals in a manner that aligns with human auditory perception, particularly concerning frequency content and spatial localization.

### SUMMARY OF THE INVENTION

The present invention introduces a Spectrogram Localization Algorithm that merges the functionalities of spectrograms and vectorscopes to create a comprehensive, real-time visual representation of an audio signal. By mapping frequency on the y-axis and stereo localization on the x-axis, the algorithm displays frequencies at their corresponding pitches and spatial positions, with colors and widths representing their amplitudes.

Utilizing a custom-designed Short-Time Fourier Transform (STFT) optimized for real-time processing, the algorithm applies psychoacoustic principles such as auditory masking and binaural localization to accurately represent how humans perceive sound. It calculates amplitude and phase differences between the left and right channels for each frequency bin, determining the spatial position of each frequency component.

This innovative approach addresses the limitations of traditional spectrograms and vectorscopes by providing detailed, frequency-specific stereo imaging information. It allows audio professionals to intuitively analyze and adjust audio signals, enhancing their ability to manage frequency content and spatial localization within a mix, leading to improved audio quality and more efficient workflows.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a flowchart illustrating the overall process of the Spectrogram Localization Algorithm. It begins with the left channel audio input (Step 101-1) and right channel audio input (Step 101-2). The audio signals are then stored in the left channel audio input buffer (Step 102-1) and right channel audio input buffer (Step 102-2). Window preprocessing is applied to both channels in Steps 103-1 and 103-2, respectively. The preprocessed data undergoes Short-Time Fourier Transforms (STFT) in Steps 104-1 and 104-2. Frequency bins are mapped to y-coordinates in Steps 105-1 and 105-2. Amplitude and phase differences are calculated for x-coordinate mapping in Step 106. Visual properties such as width, color, and transparency are modulated based on amplitude in Step 107, and the final visual representation is rendered to the screen in Step 108.

FIG. 2 provides a detailed view of the window preprocessing and STFT steps for both audio channels. After window preprocessing in Steps 103-1 and 103-2, the left and right channel samples are shifted by a step size in Steps 201-1 and 201-2. The updated windowed data is forwarded to the STFT in Steps 202-1 and 202-2. The STFT is performed on the left and right channels in Steps 104-1 and 104-2, respectively.

FIG. 3 illustrates the calculation of amplitude and phase for each channel after the STFT. Amplitude calculations are performed in Steps 301-1 (left channel) and 301-2 (right channel), while phase calculations are conducted in Steps 302-1 and 302-2. The STFT data is forwarded to the frequency bin y-coordinate mapping in Steps 303-1 and 303-2, leading to the mapping of frequency bins to y-coordinates in Steps 105-1 and 105-2.

FIG. 4 depicts the calculation of amplitude difference (Step 401) and phase difference (Step 402) between the left and right channels. Frequency-dependent weighting is applied in Step 106-1 during the mapping of amplitude and phase differences to x-coordinates in Step 106. Visual properties are modulated based on amplitude in Step 107, and the final visual representation is rendered to the screen in Step 108.

### DETAILED DESCRIPTION OF THE INVENTION

### Overview

The Spectrogram Localization Algorithm is a method and system designed to provide a comprehensive, real-time visual representation of an audio signal that closely mirrors human auditory perception. By integrating the functionalities of traditional spectrograms and vectorscopes, this invention displays frequencies along with their amplitudes while capturing stereo field nuances such as amplitude differences and phase correlations between the left and right audio channels.

### Algorithmic Process

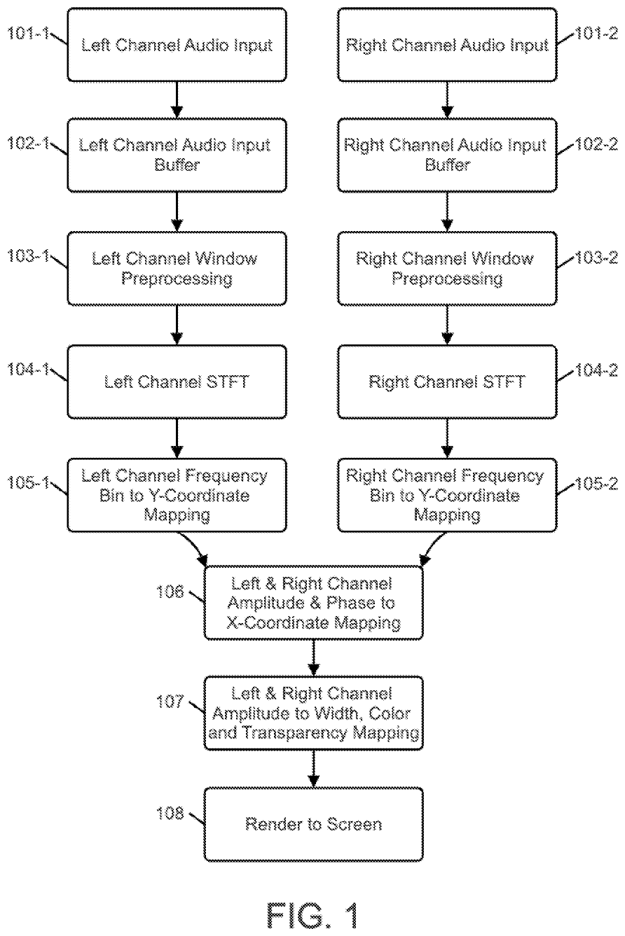

### 1. Audio Input Acquisition (Refer to FIG. 1)

Real-time audio samples are collected from both the left and right channels and stored in buffers for processing (Steps 101-1 and 101-2). The system handles audio input from various sources, including digital audio workstations (DAWs) and live audio streams. The audio inputs are stored in the left and right channel audio input buffers (Steps 102-1 and 102-2).

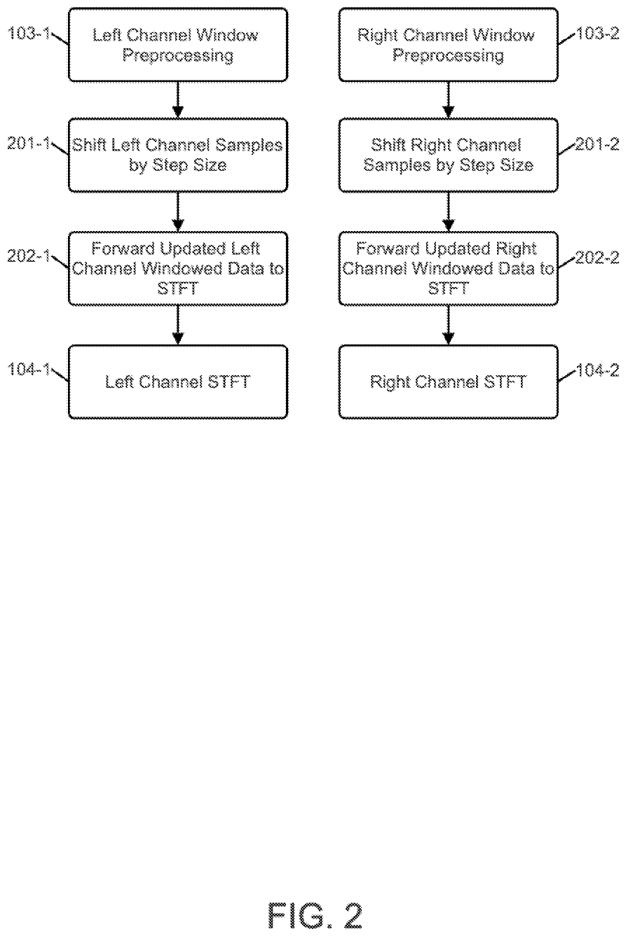

2. Preprocessing with Window Functions (Refer to FIGS. 1 and 2)

Samples from each channel are loaded into fixed-size arrays corresponding to a designated window size, typically 8,192 samples. Each sample is multiplied by a corresponding window coefficient from a windowing function, such as the Nuttall window, in the window preprocessing steps (Steps 103-1 and 103-2). This multiplication minimizes spectral leakage during the STFT processing.

To ensure overlapping windows, characteristic of STFT, after each window of data is processed, the samples in the arrays are shifted by a specified step size (Steps 201-1 and 201-2 in FIG. 2). The step size is derived by dividing the window size by a user-defined value, with higher values resulting in more overlapping windows. This overlapping enhances time-frequency resolution and provides a smoother visual update. The updated windowed data is then forwarded to the STFT (Steps 202-1 and 202-2).

### 3. Short-Time Fourier Transform (STFT) (Refer to FIGS. 1, 2, and 3)

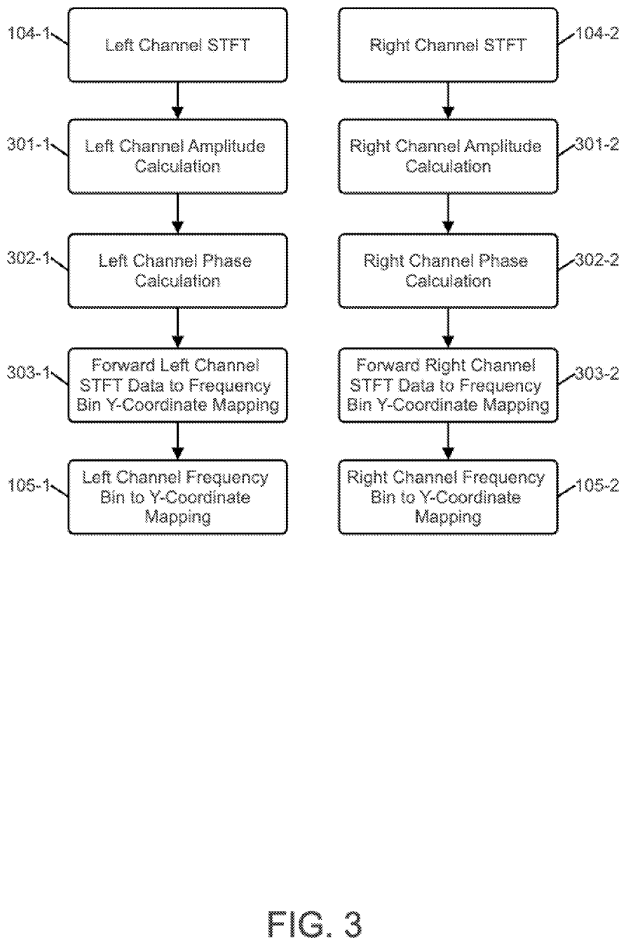

Separate in-place forward STFTs are performed on the preprocessed left and right channel data blocks (Steps 104-1 and 104-2). The transforms convert time-domain signals into frequency-domain data, extracting both real and imaginary components essential for amplitude and phase calculations.
Amplitude Calculation: For each frequency bin, the amplitude is calculated using the formula (Steps 301-1 and 301-2 in FIG. 3): Amplitude=sqrt(Real\hat{ }2+Imaginary\hat{ }2)
Phase Calculation: The phase for each frequency bin is calculated using (Steps 302-1 and 302-2): Phase =arctan(Real/Imaginary)

### 4. Frequency Bin Mapping (Y-Axis) (Refer to FIGS. 1 and 3)

Each frequency bin is assigned a y-coordinate based on its frequency, using logarithmic scaling to reflect human pitch perception (Steps 105-1 and 105-2). Frequencies can range from DC to the Nyquist frequency, the human audible range, or any range within.

Given the limited pixel resolution of displays, not all frequency bins can be assigned to individual pixels. To maximize perceptual relevance, the algorithm assigns each frequency bin to a pixel and displays the one with the highest relative amplitude within that pixel's frequency range. This approach aligns with the psychoacoustic phenomenon of frequency masking, where louder sounds at a given frequency mask quieter sounds at neighboring frequencies.

Interpolation methods, such as lanczos interpolation for inter-frequency bin analysis, are used to enhance visual resolution, especially at lower frequencies where bins are sparse.

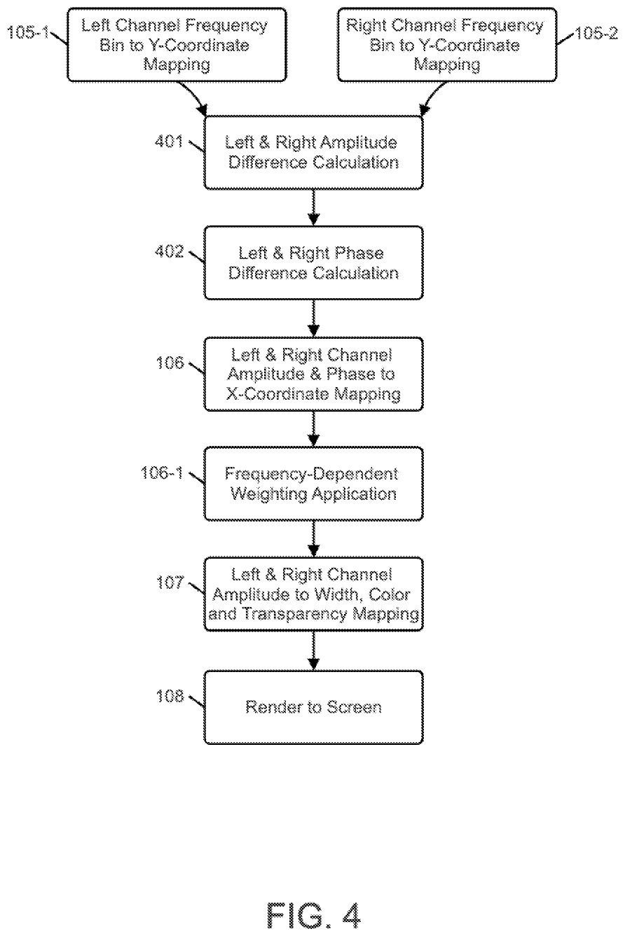

### 5. Amplitude Representation (Refer to FIGS. 1 and 4)

The amplitude of each frequency bin influences visual characteristics such as color, transparency, and width. Visual properties are modulated based on amplitude in Step 107.
Color and Transparency: Frequencies with higher amplitudes are represented with brighter colors and less transparency, while lower amplitudes appear more transparent. The color of each frequency bin can be defined by a given number of user defined colors, and can be further influenced by other user defined parameters such as the dynamic range, or brightness of the display. The primary color can be assigned to frequencies with amplitudes greater than or equal to 0 dB and blends with the secondary color at lower amplitudes.
Width: The width of each frequency representation along the x-axis is influenced by its amplitude. A base pixel width can be defined, where the width extends beyond this value when the amplitude exceeds 0 dB, allowing louder frequencies to appear more prominent.

### 6. Stereo Localization Calculation (X-Axis) (Refer to FIGS. 1 and 4)

The x-axis represents the spatial positioning of frequencies, determined by calculating amplitude and phase differences between the left and right channels for each frequency bin.
Amplitude Difference (Step 401): The normalized amplitude difference between the left and right channels is calculated using: Amplitude Difference=AmplitudeL+AmplitudeR/AmplitudeL−AmplitudeR
Phase Difference (Step 402): The phase difference between the left and right channels is calculated as: Phase Difference=PhaseL−PhaseR To ensure the phase difference remains within −180° to 180°, phase wrapping is applied: Phase Difference Normalized=((Phase Difference+540°)mod 360°)−180°

These differences are used to calculate the x-coordinate positions for each frequency bin in Step 106, simulating spatial localization as perceived by the human auditory system.
Spatial Mapping Based on Frequency (Step 106-1):
   Below 1,280 Hz: Both amplitude and phase differences equally influence stereo localization. The algorithm calculates the average of the amplitude and phase difference ratios to determine the x-axis position.
   Between 1,280 Hz and 2,560 Hz: Amplitude differences have increasing influence, while phase differences have decreasing influence.
   Above 2,560 Hz: Only amplitude differences are considered due to the decreased reliability of phase cues at higher frequencies.
X-Axis Position Determination: The x-axis position for each frequency bin is calculated based on the amplitude difference and phase difference normalized values, considering the frequency-dependent weighting. This calculation involves mapping the amplitude and phase differences to positions along the x-axis, where the center represents a balanced stereo image, the left side represents sounds localized to the left, and the right side represents sounds localized to the right.

### 7. Rendering the Visual Representation (Refer to FIGS. 1 and 4)

Frequency bins are plotted on a two-dimensional display using the calculated x and y coordinates. The visual representation updates in real-time, reflecting changes in the audio signal immediately. The system can be fully resizable. The final visual representation is rendered to the screen in Step 108.

### Embodiments and Variations

### Adjustable Parameters

Frequency Bounds: Users can adjust minimum and maximum frequency bounds by scrolling or dragging within the display or by manually inputting values.
Visual Properties: Visual properties such as color schemes, transparency levels, dynamic range, and brightness can be customized using sliders and controls within the interface.
Slope Weighting: A Slope Weight Slider allows users to control amplitude weighting from low to high frequencies.

### Headphone and Speaker Modes

### The algorithm includes modes that simulate listening through headphones or speakers.

Headphone Mode: Processes the raw audio input, suitable for users monitoring with headphones.
Speaker Mode: Applies a crossfeed algorithm to emulate the perceptual effects of speaker listening, accounting for differences in stereo imaging, especially at low frequencies.

### Frequency Tracking

The system can include a frequency tracking module that identifies and displays the frequency with the highest relative amplitude within a defined range, along with its amplitude and musical note value.

### Performance Optimization

Multithreading: The algorithm supports multithreading to optimize computational performance during the STFT calculations for left and right channels.
Dynamic Processing Load: Processing load is adjusted based on the display size and resolution to maintain performance efficiency.

### Implementation Details

### Windowing and Overlap

The use of window functions like the Nuttall window minimizes spectral leakage and improves the accuracy of the STFT. Overlapping windows ensure continuous analysis of the audio signal, providing smooth and accurate visual updates.

### Interpolation Techniques

Advanced interpolation methods, such as an optimized Lanczos interpolation algorithm, can enhance the display's visual fidelity, especially in frequency ranges with fewer bins. This allows for a more precise and perceptually accurate representation of the audio signal.

### Scalability and Compatibility

The system is designed to integrate seamlessly with various DAWs and audio processing environments. It is compatible with standard audio formats and can be implemented as a plugin or standalone application.

### Advantages of the Invention

Enhanced Perceptual Alignment: By mapping frequencies and stereo localization in a manner that reflects human auditory perception, the invention provides a more intuitive understanding of audio signals.
Comprehensive Analysis: The integration of amplitude, frequency, and stereo imaging information allows for detailed inspection and adjustment of specific frequencies and spatial characteristics within a mix.
Real-Time Processing: Optimizations in the algorithm enable high frame rates and efficient CPU usage, ensuring that the visual representation remains responsive to changes in the audio input.
User Customization: The ability to adjust visual parameters and modes empowers users to tailor the system to their specific needs and preferences.

Although the present disclosure has been explained in relation to its preferred embodiment, it is to be understood that many other possible modifications and variations can be made without departing from the spirit and scope of the disclosure.

The invention claimed is:

1. A method for providing a real-time visual representation of an audio signal that integrates frequency content and stereo localization, the method comprising:
performing separate Short-Time Fourier Transforms (STFT) on left and right audio channels to obtain amplitude and phase information for each frequency bin;
mapping each frequency bin to a y-axis coordinate based on its frequency using logarithmic scaling;
calculating amplitude differences and phase differences between the left and right channels for each frequency bin;
determining x-axis coordinates for each frequency bin based on the calculated amplitude and phase differences to represent stereo localization, wherein frequency-dependent weighting is applied to the influence of amplitude and phase differences;
modulating visual properties of each frequency bin, including color, transparency, and width, based on its amplitude;
displaying the frequency bins on a two-dimensional display using the calculated x and y coordinates, thereby providing a real-time visual representation that reflects human auditory perception.

2. The method of claim 1, wherein the amplitude difference for each frequency bin is calculated using the formula: Amplitude Difference=AmplitudeL+AmplitudeR/AmplitudeL−AmplitudeR

3. The method of claim 1, wherein the phase difference between the left and right channels for each frequency bin is calculated using:
Phase Difference =PhaseL-PhaseR and normalized to a range of −180 degrees to 180 degrees using phase wrapping techniques:
Phase Difference Normalized=((Phase Difference+540°)mod 360°)−180°

4. The method of claim 1, wherein the frequency-dependent weighting of amplitude and phase differences is such that:
below a first threshold frequency, both amplitude and phase differences equally influence stereo localization;
between the first threshold frequency and a second higher threshold frequency, amplitude differences have increasing influence while phase differences have decreasing influence;
above the second threshold frequency, only amplitude differences influence stereo localization.

5. The method of claim 1, further comprising applying a windowing function to the audio samples prior to performing the Short-Time Fourier Transforms to minimize spectral leakage.

6. The method of claim 5, wherein the windowing function is selected from the group consisting of Nuttall, Hann, Hamming, and Blackman windows.

7. The method of claim 1, further comprising overlapping the windows in the Short-Time Fourier Transform processing to enhance time-frequency resolution.

8. The method of claim 1, wherein interpolation methods are used to enhance the visual resolution of frequency representations, particularly at lower frequencies.

9. The method of claim 1, further comprising allowing user adjustment of visualization parameters, including minimum and maximum frequency bounds, color schemes, transparency levels, amplitude thresholds, and slope weighting.

10. A system for real-time audio visualization, the system comprising:
an input module configured to acquire audio signals from left and right channels;
a processing module configured to perform the method steps of any of claims 1 through 9;
a display module configured to render the visual representation on a two-dimensional display.

11. The system of claim 10, wherein the processing module supports multithreading to optimize computational performance.

12. The system of claim 10, further comprising a user interface that allows adjustment of visualization parameters and modes, including headphone and speaker simulation modes.
